(19) United States
(12) Patent Application Publication
(10) Pub. No.: US 2009/0055756 A1
(43) Pub. Date: Feb. 26, 2009

(54) DOUBLY LINKED VISUAL DISCUSSIONS FOR DATA VISUALIZATION

(75) Inventors: Jeffrey Heer, San Francisco, CA (US); Jesse H. Kriss, Cambridge, MA (US); Franciscus J. J. van Ham, Cambridge, MA (US); Fernanda B. Viegas, Boston, MA (US); Martin M. Wattenberg, Winchester, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/844,833

(22) Filed: Aug. 24, 2007

(51) Int. Cl. G06F 3/048; G06F 3/01

(52) U.S. Cl. 715/760; 715/764

(57) ABSTRACT

Embodiments of the present invention address deficiencies of the art in respect to data visualization and provide a novel and non-obvious method, system and computer program product for doubly linked visual discussions for data visualization. In one embodiment of the invention, a method for doubly-linked data visualization can be provided. The method can include rendering a data visualization in a data visualization service user interface, identifying comments corresponding to the rendered data visualization, concurrently displaying the identified comments in the user interface, selecting a comment in the user interface, and replacing the rendered data visualization in the user interface with a different data visualization corresponding to the selected comment.

### BACKGROUND OF THE INVENTION

1. Field of the Invention

The present invention relates to the field of data reduction computing systems and more particularly to data visualization for data reduction.

2. Description of the Related Art

Database management systems have fueled the utility of computing for a substantial portion of end users for many decades. Conventional database management systems allow for the structured storage of mass quantities of data and also conventional database management systems provide an interface through which the data can be sorted, filtered and queried. The manipulation of stored data in a database management system provides the end user with unlimited ways to relate data so as to intelligently analyze the context and meaning of the stored data in manner not previously possible when analyzing data on paper without the assistance of a computer.

For some database management systems holding only a limited number of data types in each record, data can only be related to one another in so many ways such that the manipulation of stored data afforded by the database management system can suffice in facilitating a competent reduction of the data. Strictly speaking, data acquisition refers to the collection and storage of data in a database management system, while data reduction refers to the analysis of data in a database management system to apply meaning to the collected and stored data. Integral to the modern data reduction process, data, data visualization further facilitates a mental understanding of the interrelationship between different types of data stored in a database management system.

Data visualization is a technique that allows a user of a database system to view information about data stored in the database along different dimensions. The data visualizations that are created to display the information can take on various forms. One typical form is that of a table layout, with each row representing a record in the database and each column representing a field from the record. The table usually lists a subset of the database records and a subset of the available fields in the database records. Furthermore, the table can be ordered as an aid to navigation. A general overview of data visualization can be found in U.S. Pat. No. 6,529,900 to Patterson et al. for METHOD AND APPARATUS FOR DATA VISUALIZATION issued on Mar. 4, 2003.

Providing a data visualization for tabular data can prove helpful in realizing meaning for the tabular data for an interested person. However, for the lone viewer of a data visualization, the analysis can be limited to the knowledge and experience of the lone viewer. Substantially more thorough and deep analysis can be achieved where multiple different viewers access the same data visualization and share interpretations. In the modern data visualization tool, however, the number and hence quality of analysis for a data visualization can be limited to those physically present to view the data visualization produced for a data set.

### BRIEF SUMMARY OF THE INVENTION

Embodiments of the present invention address deficiencies of the art in respect to data visualization and provide a novel and non-obvious method, system and computer program product for doubly linked visual discussions for data visualization. In one embodiment of the invention, a method for doubly-linked data visualization can be provided. The method can include rendering a data visualization in a data visualization service user interface, identifying comments corresponding to the rendered data visualization, concurrently displaying the identified comments in the user interface, selecting a comment in the user interface, and replacing the rendered data visualization in the user interface with a different data visualization corresponding to the selected comment. In one aspect of the embodiment, the method further can include composing a comment pertaining to the rendered data visualization in the user interface, associating the composed comment with the rendered data visualization in the user interface and displaying the composed comment responsive to a display of the rendered data visualization in the user interface.

In another aspect of the embodiment, rendering a data visualization in a data visualization service user interface can include uploading a data subset from over a computer communications network, selecting a data visualization type for the uploaded data subset, generating a data visualization of the selected data visualization type for the uploaded data subset, and displaying the generated data visualization in the user interface. As such, the method further can include bookmarking different data visualizations for the uploaded data subset, displaying different bookmarks for the different data visualizations in the user interface, selecting one of the different bookmarks, and replacing the rendered data visualization in the user interface with a different data visualization corresponding to the selected one of the different bookmarks. Further, displaying the generated data visualization in the user interface can include displaying the generated data visualization in a Web page in a content browser.

In another embodiment of the invention, a data visualization data processing system can be provided. The system can include a server, a data visualization processor executing in the server, a data visualization service coupled to the data visualization processor and executing in the server, and doubly-linked visual discussions logic coupled to the data visualization service. The logic can include program code enabled to identify comments in a user interface, such as a Web page, for the data visualization service corresponding to a rendered data visualization, to concurrently displaying the identified comments in the user interface, and to replace the rendered data visualization in the user interface with a different data visualization corresponding to a selected comment in the user interface. The system optionally can include a bookmark view including selectable bookmarks. Each of the bookmarks further can correspond to a different data visualization for an uploaded data set.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a screen shot of a data visualization user interface configured for doubly linked visual discussions for data visualization;

FIG. 2 is a schematic illustration of a data visualization data processing system configured for doubly linked visual discussions for data visualization; and,

FIG. 3 is a flow chart illustrating a process for doubly linked visual discussions for data visualization.

### DETAILED DESCRIPTION OF THE INVENTION

Embodiments of the present invention provide a method, system and computer program product for doubly linked visual discussions for data visualization. In accordance with an embodiment of the present invention, different data visualizations for a data set can be produced. Different threads of textual commentary can be received from multiple different users viewing the different data visualizations. Selection and rendering of a given one of the different data visualizations can result in the concurrent display of a corresponding one of the different threads of textual commentary. Likewise, a selection of a given one of the different threads of commentary can result in the concurrent display of a corresponding one of the different data visualizations.

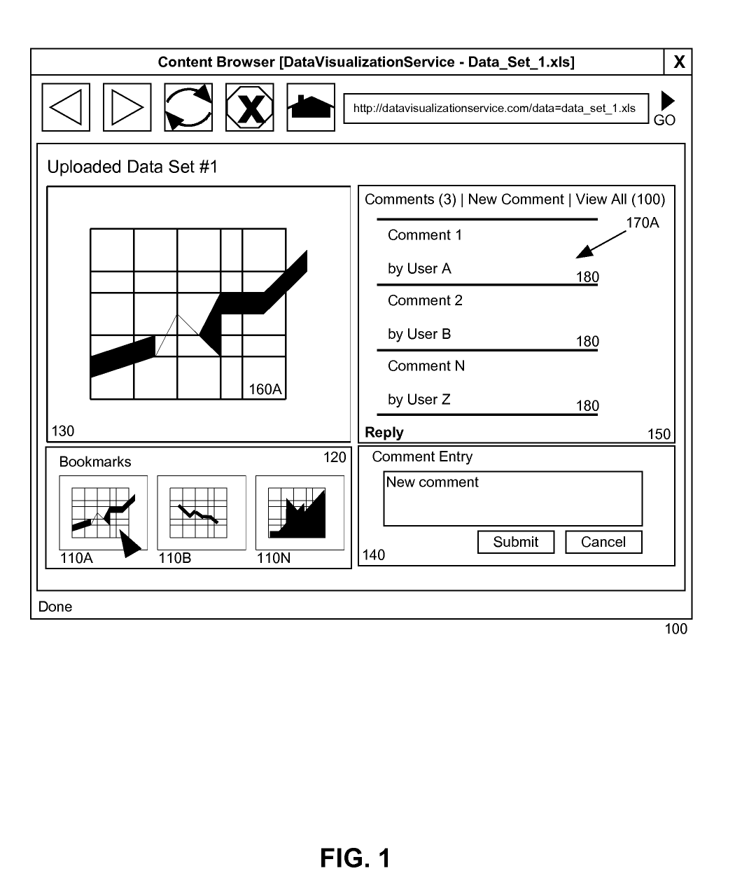

In further illustration, FIG. 1 is a screen shot of a data visualization user interface configured for doubly linked visual discussions for data visualization. As shown in FIG. 1, a content browser 100 can provide a rendering of a data visualization user interface for an uploaded data set. The data visualization user interface can include a bookmark view 120, a data visualization view 130, a comment entry view 140 and a comment thread view 150. The bookmark view 120 can include one or more bookmarks 110A, 110B, 110N each associated with a corresponding data visualization for an uploaded data set. The data visualization view 130, in turn, can include a rendered data visualization 160A of the uploaded data set. In this regard, a selection of one of the bookmarks 110A, 110B, 110N can result in the placement of a corresponding rendering in the data visualization view 130.

The comment thread view 150 can include a display 170A of comments 180 either exclusively pertaining to the rendered data visualization 160A in the data visualization view 130. Alternatively, the comment thread view 150 can include a display of all comments 180 irrespective of the relationship of the comments 180 to the content of the data visualization view 130. Newly composed ones of the comments 180 can be added to the comment thread view 150 through comment entry view 140. Newly added ones of the comments 180 can be added to the comment thread view 150 in association with the data visualization rendered in the data visualization view 130. Notably, the selection of any of the comments 180 in the comment thread view 150 can result in the placement of an associated data visualization in the data visualization view 130. In this way, the comments 180 and rendered data visualizations 160A can be doubly-linked to one another.

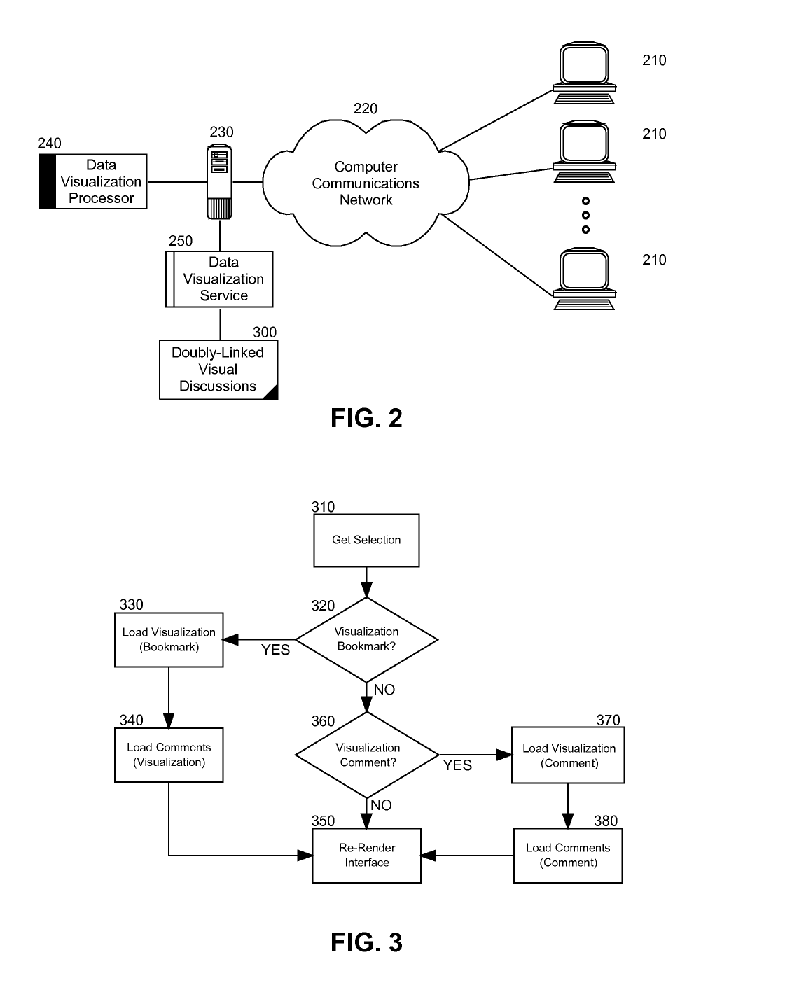

The data visualization user interface can be configured for doubly linked visual discussions for data visualization in a data visualization data processing system. In illustration, FIG. 2 schematically depicts a data visualization data processing system configured for doubly linked visual discussions for data visualization. The system can include a server 230 configured for communicative coupling to one or more clients 210 over computer communications network 220. The server 230 can support the operation of a data visualization processor 240. The data visualization processor 240 can be configured to transform tabular data in a data set to a visualized form, for example a two-dimensional or three-dimensional graph, pie chart, bar chart, and the like.

The server 230 also can support the operation of a data visualization service 250. The data visualization service 250 can provide an interface through which data sets can be uploaded and provided to the data visualization processor 240 for transformation into a selected data visualization. The data visualization service 250 further can provide an interface through which different visualization types can be selected and selected visualizations can be parameterized to generate a data visualization for an uploaded data set. Notably, doubly-linked visual discussions logic 300 can be coupled to the data visualization service 250.

The logic 300 can include program code enabled to present a user interface both with multiple different data visualizations for an uploaded data set, and corresponding comments associated with each rendered data one of the data visualizations for the uploaded data set. The program code further can be enabled to emphasize or otherwise render dominantly in the user interface a specific data visualization corresponding to either a selected comment in a comment thread view of the user interface, or a bookmark to the specific data visualization. Conversely, the program code can be yet further enabled to display only those comments associated with an emphasized or other dominantly rendered specified data visualization.

In further illustration of the operation of the program code of the doubly-linked visual discussions logic 300, FIG. 3 is a flow chart illustrating a process for doubly linked visual discussions for data visualization. Beginning in block 310 a selection event can be received in a user interface for the data visualization service. In decision block 320, it can be determined whether a specific data visualization bookmark has been selected. If so, in block 330, the corresponding data visualization for the selected bookmark can be loaded for rendering in the user interface. Also, in block 340 associated comments for the data visualization rendered in the user interface can be loaded for concurrent rendering in the user interface. Finally, in block 350, the user interface can be refreshed for viewing by end users.

In decision block 330, if it is determined that a visualization comment has been selected within the user interface, in block 370 a data visualization associated with the selected visualization comment can be loaded for rendering in the user interface. Also, in block 380, the comments associated with the selected visualization comment can be loaded for concurrent rendering in the user interface. Finally, in block 350, the user interface can be refreshed for viewing by end users. Consequently, the visualization comments for a rendered data visualization for an uploaded data set, and the rendered data visualization can be doubly-linked so that the selection of one results in the display of the other.

In an aspect of the embodiment, the state of a rendered data visualization can be defined by parameter settings, for instance, a search term used to filter a database so that only rows containing the search term are visualized in the rendered data visualization. Yet, parameter settings need not have a one-to-one mapping to visualization states as a single visualization state can result from different parameter settings. Therefore, to associate comments with selected visualizations can require an indexing mechanism which identifies visualization states that are equivalent despite having different parametric representations.

To address the foregoing scenario, filter parameters and view parameters can be distinguished from one another. Specifically, filter parameters can determine which data elements are visible in the display. Accordingly, rather than index filter parameters directly, the filtered state of the application can be indexed by noting which data is currently visible rather than the filter parameters giving rise to the currently visible data, thereby capturing the case when different filter parameters give rise to the same filtered state. View parameters, on the other hand, adjust visual mappings, such as selecting a normalized or absolute axis scale. View parameters can be indexed directly. Optionally, the linking mechanism described herein implements the two-part index by computing a probabilistically unique hash code value based on both the visible data and the view parameters giving rise to the visible data in the data visualization. These computed hash values subsequently can be used as keys for retrieving comments for a current visualization state.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for doubly-linked data visualization, the method comprising:
rendering a data visualization in a data visualization service user interface;
identifying comments corresponding to the rendered data visualization;
concurrently displaying the identified comments in the user interface;
selecting a comment in the user interface; and,
replacing the rendered data visualization in the user interface with a different data visualization corresponding to the selected comment.

2. The method of claim 1, wherein rendering a data visualization in a data visualization service user interface, comprises:
uploading a data subset from over a computer communications network;
selecting a data visualization type for the uploaded data subset;
generating a data visualization of the selected data visualization type for the uploaded data subset; and,
displaying the generated data visualization in the user interface.

3. The method of claim 2, further comprising:
bookmarking different data visualizations for the uploaded data subset;
displaying different bookmarks for the different data visualizations in the user interface;
selecting one of the different bookmarks; and,
replacing the rendered data visualization in the user interface with a different data visualization corresponding to the selected one of the different bookmarks.

4. The method of claim 1, wherein identifying comments corresponding to the rendered data visualization, comprises identifying comments corresponding to visible data in the rendered data visualization

5. The method of claim 1, wherein identifying comments corresponding to the rendered data visualization, comprises identifying comments corresponding to hash value computed for visible data in the rendered data visualization

6. The method of claim 2, wherein displaying the generated data visualization in the user interface, comprises displaying the generated data visualization in a Web page in a content browser.

7. The method of claim 1, further comprising:
composing a comment pertaining to the rendered data visualization in the user interface;
associating the composed comment with the rendered data visualization in the user interface; and,
displaying the composed comment responsive to a display of the rendered data visualization in the user interface.

8. A data visualization data processing system comprising:
a server;
a data visualization processor executing in the server;
a data visualization service coupled to the data visualization processor and executing in the server; and,
doubly-linked visual discussions logic coupled to the data visualization service, the logic comprising program code enabled to identify comments in a user interface for the data visualization service corresponding to a rendered data visualization, to concurrently displaying the identified comments in the user interface, and to replace the rendered data visualization in the user interface with a different data visualization corresponding to a selected comment in the user interface.

9. The system of claim 8, wherein the user interface is a Web page.

10. The system of claim 8, further comprising a bookmark view comprising a plurality of selectable bookmarks each of the bookmarks corresponding to a different data visualization for an uploaded data set.

11. A computer program product comprising a computer usable medium embodying computer usable program code for doubly-linked data visualization, the computer program product comprising:
computer usable program code for rendering a data visualization in a data visualization service user interface;
computer usable program code for identifying comments corresponding to the rendered data visualization;
computer usable program code for concurrently displaying the identified comments in the user interface;
computer usable program code for selecting a comment in the user interface; and,
computer usable program code for replacing the rendered data visualization in the user interface with a different data visualization corresponding to the selected comment.

12. The computer program product of claim 11, wherein the computer usable program code for rendering a data visualization in a data visualization service user interface, comprises:
computer usable program code for uploading a data subset from over a computer communications network;
computer usable program code for selecting a data visualization type for the uploaded data subset;
computer usable program code for generating a data visualization of the selected data visualization type for the uploaded data subset; and,
computer usable program code for displaying the generated data visualization in the user interface.

13. The computer program product of claim 12, further comprising:
computer usable program code for bookmarking different data visualizations for the uploaded data subset;
computer usable program code for displaying different bookmarks for the different data visualizations in the user interface;
computer usable program code for selecting one of the different bookmarks; and,
computer usable program code for replacing the rendered data visualization in the user interface with a different data visualization corresponding to the selected one of the different bookmarks.

14. The computer program product of claim 11, wherein identifying comments corresponding to the rendered data visualization, comprises identifying comments corresponding to visible data in the rendered data visualization

15. The computer program product of claim 11, wherein identifying comments corresponding to the rendered data visualization, comprises identifying comments corresponding to hash value computed for visible data in the rendered data visualization

16. The computer program product of claim 12, wherein the computer usable program code for displaying the generated data visualization in the user interface, comprises computer usable program code for displaying the generated data visualization in a Web page in a content browser.

17. The computer program product of claim 11, further comprising:
computer usable program code for composing a comment pertaining to the rendered data visualization in the user interface;
computer usable program code for associating the composed comment with the rendered data visualization in the user interface; and,
computer usable program code for displaying the composed comment responsive to a display of the rendered data visualization in the user interface.
